(19) United States
(12) Patent Application Publication
(10) Pub. No.: US 2020/0175448 A1
(43) Pub. Date: Jun. 4, 2020

(54) BIDIRECTIONAL SMOOTHING OF ACTIVITY PACING PLANS

(71) Applicant: Microsoft Technology Licensing, LLC, Redmond, WA (US)

(72) Inventors: Xi Chen, San Jose, CA (US); Yu Wang, Sunnyvale, CA (US)

(73) Assignee: Microsoft Technology Licensing, LLC, Redmond, WA (US)

(21) Appl. No.: 16/204,574

(22) Filed: Nov. 29, 2018

(51) Int. Cl. G06Q 10/06; G06N 20/00; G06Q 10/10

(52) U.S. Cl. CPC G06Q 10/06316; G06Q 10/105; G06N 20/00

(57) ABSTRACT

The disclosed embodiments provide a system for performing bidirectional smoothing of activity pacing plans. During operation, the system obtains historical data comprising a time series of activity with an online system. Next, the system executes a Bayesian model that performs forward filtering of the time series to generate a pacing curve containing smoothed values of the time series over a period. The system then performs a backward smoothing that updates each of the smoothed values based on subsequent values in the time series. Finally, the system adjusts an occurrence of the activity over the period based on the pacing curve.

### BACKGROUND

### Field

The disclosed embodiments relate to pacing of activities. More specifically, the disclosed embodiments relate to techniques for performing bidirectional smoothing of activity pacing plans.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for pacing activities in accordance with the disclosed embodiments.

FIG. 3 shows a flowchart illustrating a process of pacing an activity in accordance with the disclosed embodiments.

FIG. 4 shows a flowchart illustrating a process of using a pacing curve to adjust an occurrence of interactions with a job in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for pacing activities associated with time-based constraints. For example, the disclosed embodiments may be used to produce a “pacing plan” for jobs that are posted in an online system. Each job may be associated with a daily budget that is spent as users view, click on, apply to, and/or perform other actions related to the job. As a result, the pacing plan may be used to control and/or adjust the delivery of the jobs to the users so that the budget can be consumed over the course of the day instead of running out too early and/or failing to be used up by the time the day ends.

More specifically, the disclosed embodiments utilize a Bayesian model with forward filtering and backward smoothing to generate a pacing curve from historical data containing a time series of an activity. For example, the pacing curve may be generated from counts of views, clicks, applies, and/or other actions related to jobs over fixed time intervals. During forward filtering, the Bayesian model iterates over the time series in a forward direction and produces a pacing curve containing a series of smoothed values for the activity. Within the Bayesian model, the distribution of a value at a given time step may be based on the distribution of the value at a prior time step, a current observation associated with the value from the time series, and/or a discount factor. During backward smoothing, values in the pacing curve are adjusted in a backwards direction, with each value updated based on information for subsequent time steps from the Bayesian model.

The pacing curve is then used to adjust and/or control the occurrence of the activity over a prescribed period. For example, the pacing curve may be used in a pacing plan that adjusts the exposure of users to jobs over a day based on budgets associated with the jobs. At a given point in the day, the pacing plan calculates an expected utilization of a job's budget up to the point based on the pacing curve and compares the expected utilization to the actual utilization of the job's budget at the point. Subsequent exposure of users to the job may then be throttled if the actual utilization is higher than the expected utilization and boosted if the actual utilization is lower than the expected utilization.

By using Bayesian inference to generate smooth pacing plans for activities that are associated with time-based constraints, the disclosed embodiments may introduce changes to pacing of the activities in a gradual, stable manner while temporally distributing the activities in a way that better meets the constraints. In contrast, conventional techniques may perform pacing based on unprocessed historical data, which can be inaccurate, noisy, and/or result in abrupt changes to user experiences. Consequently, the disclosed embodiments may provide improvements in computer systems, applications, user experiences, tools, and/or technologies related to delivering online content and/or carrying out activities within online systems.

### Bidirectional Smoothing of Activity Pacing Plans

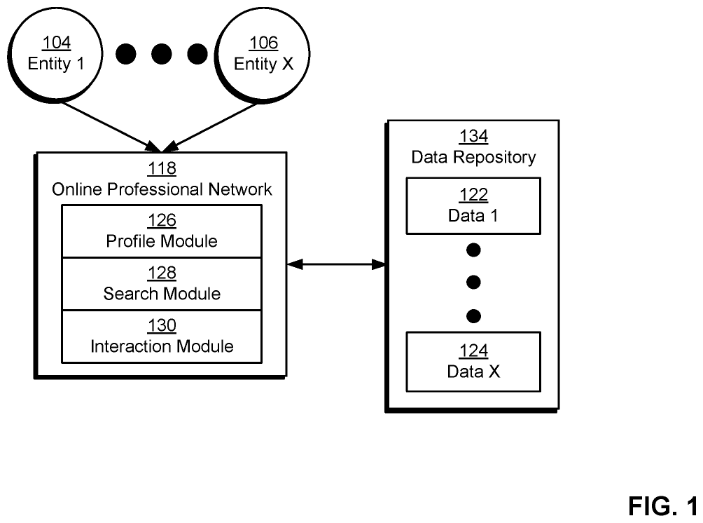

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, applications, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings related to candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

Jobs, advertisements, and/or other types of content displayed or delivered within online network 118 may also be associated with time-based limitations or constraints. For example, posters of jobs may pay per view, click, apply, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

In one or more embodiments, online network 118 manages daily budgets and/or other time-based constraints associated with content in online network 118 by pacing the delivery of the content across the periods over which the resources are allocated. For example, online network 118 may use “pacing plans” for jobs, advertisements, and/or other content to adjust the rate at which users are exposed to the content so that consumption of the budgets for the content is spread over the period for which the budgets are allocated (e.g., a given day).

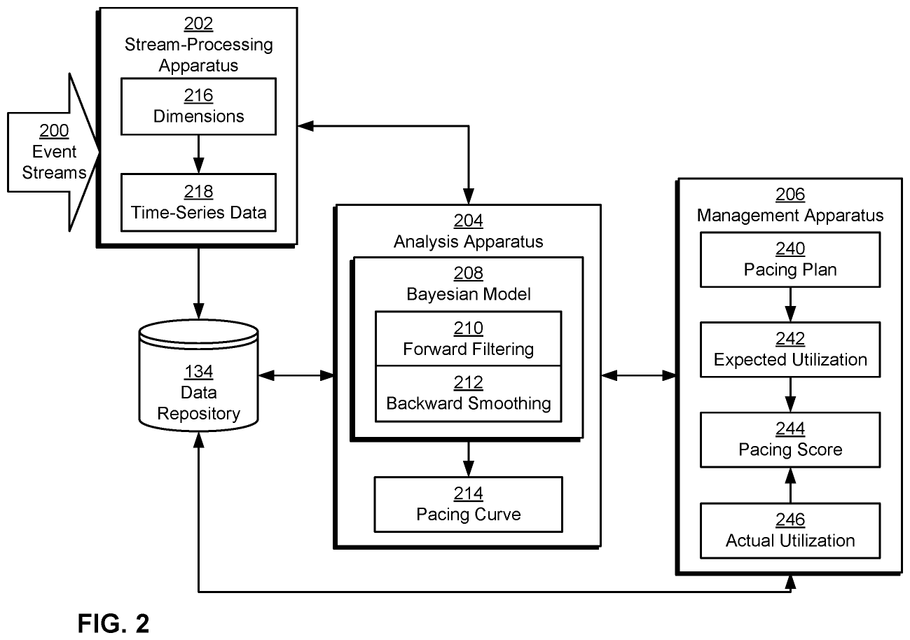

As described in further detail below with respect to FIG. 2, each pacing plan may be based on a pacing curve that is generated from historical data for actions related to the content. For example, a pacing curve for jobs in online network 118 may be generated from a time series of historical views, clicks, applies, and/or other actions related to the jobs. To remove noise from the pacing curve, a Bayesian model may be used to smooth the time series in the forward and backward directions. The pacing curve may then be used to control the consumption of the jobs' budgets over a day by throttling delivery of the jobs when the jobs' budgets are utilized faster than expected at any given point and increasing delivery of the jobs when the jobs' budgets are utilized slower than expected at any given point.

FIG. 2 shows a system for pacing activities in accordance with the disclosed embodiments. As shown in FIG. 2, the system includes a stream-processing apparatus 202, an analysis apparatus 204, and a management apparatus 206. Each of these components is described in further detail below.

Stream-processing apparatus 202 generates time-series data 218 from event streams 200 containing records of page views, clicks, and/or other activity collected from the monitored systems; performance metrics associated with the activity, such as page load times; and/or other time-series data from the monitored systems. For example, event streams 200 may be generated and/or maintained using a distributed streaming platform such as Apache Kafka (Kafka™ is a registered trademark of the Apache Software Foundation). When a profile update, job search, job view, job application, response to a job application, connection invitation, post, like, comment, share, purchase, conversion, member registration, and/or other recent activity occurs within or outside an online system (e.g., online network 118 of FIG. 1), a publisher in the distributed streaming platform generates a record of the activity. The distributed streaming platform may then propagate the record to components subscribing to event streams 200, such as stream-processing apparatus 202.

To generate time-series data 218 from events in event stream 200, stream-processing apparatus 202 aggregates records of the events along one or more dimensions 216. For example, stream-processing apparatus 202 may aggregate page views, clicks, applies, and/or other types of activity into time-series data 218 based on dimensions 216 such as location or region (e.g., states within the United States); keys of the corresponding web pages, jobs, advertisements, and/or other content; and/or user or job attributes such as language, industry, seniority, education, experience, and/or skills. Such aggregated metrics may include, but are not limited to, a median, a quantile (e.g., 90^{th} percentile), a variance, a mean, a maximum, a minimum, a count (e.g., number of views accumulated over the course of a day), and/or other summary statistics.

In addition, stream-processing apparatus 202 may aggregate events from event stream 200 in a number of ways. For example, stream-processing apparatus 202 may aggregate sets of a pre-defined consecutive number (e.g., 1000) of events for a given location and key into a single aggregated record. Alternatively, stream-processing apparatus 202 may aggregate records received from event stream 200 along pre-specified intervals (e.g., five-minute intervals) independently of the number of events generated within each interval.

After time-series data 218 is produced, stream-processing apparatus 202 stores time-series data 218 in data repository 134 and/or another data store for subsequent retrieval and use. Stream-processing apparatus 202 may optionally transmit a portion of time-series data 218 directly to analysis apparatus 204, in lieu of or in addition to storing time-series data 218 in the data store.

Analysis apparatus 204 applies a Bayesian model 208 to historical time-series data 218 to produce a pacing curve 214 for the corresponding activity. First, analysis apparatus 204 retrieves, from stream-processing apparatus 202, data repository 134, and/or another data source, time-series data 218 that spans a certain number of weeks or months before the current time. For example, analysis apparatus 204 may obtain time-series data 218 as cumulative counts of views, clicks, searches, applies, and/or other interactions with jobs at five-minute intervals over the course of each day, which may start at a standardized time (e.g., UTC+0). The cumulative counts may start at 0 or a relatively low number at the beginning of the day and gradually increase throughout the day as the corresponding interactions occur. After the day lapses, the cumulative counts may reset to 0 for tracking of the interactions over the subsequent day.

Next, analysis apparatus 204 further aggregates the retrieved time-series data 218 over a smaller, repeating interval prior to inputting time-series data 218 into Bayesian model 208. For example, analysis apparatus 204 may sum, average, concatenate, group, and/or otherwise combine or condense multiple weeks of time-series data 218 into a one-week period to facilitate subsequent identification of weekly seasonal patterns in the corresponding activity. In a more specific example, if each point in time-series data 218 represents a five-minute interval on a certain day of the week (e.g., 12:00 am to 12:05 am on Monday), analysis apparatus 204 may aggregate time-series data 218 into the point by summing the cumulative counts of interactions during that interval across multiple weeks (e.g., summing 15 counts of job views from 12:00 am to 12:05 am on Mondays over a 15-week period of time-series data 218).

In one or more embodiments, Bayesian model 208 includes a Bayesian Poisson-Gamma time series model that performs Bayesian filtering and/or smoothing of noisy and/or sparse time-series data 218 to generate pacing curve 214 based on an estimate of the underlying distribution of values associated with the activity at fixed intervals (e.g., every five minutes). To produce pacing curve 214, analysis apparatus 204 performs forward filtering 210 of each time step in Bayesian model 208 based on previous time steps in Bayesian model 208. After forward filtering 210 is complete, analysis apparatus 204 also performs backward smoothing 212 of each time step based on information for subsequent time steps in Bayesian model 208 and/or time-series data 218.

The operation of Bayesian model 208 is illustrated using a non-negative count time series (e.g., time-series data 218) denoted by xₜ, which represents observations of a latent variable ϕₜ with a Poisson distribution that is conditionally independent over time steps t=1, 2, . . . , T. The ϕₜ process evolves via the following Markov model:

ϕₜ=ϕₜ₋₁ηₜ/δₜ, ηₜ˜Be(δₜrₜ,(1−δₜ)rₜ),

Θₜ⊥⊥θₛ, ∀s<t and Θₜ⊥⊥ϕₛ, ∀s<=t

In the above representation, δₜ∈(0, 1) denotes a discount factor, ηₜ represents Beta-distributed random noise, and rₜ is a known function of t, x_{0:t-1}, and independent innovations (i.e., statistical errors) ηₜ/δₜ.

During forward filtering 210, a latent state ϕ₀˜Ga(r₀, c₀) (where r₀, c₀>0 are known) is introduced at time t=0, and x₀ is used as notation for all available information at time t=0. At time t−1, the posterior for the current Poisson rate given the initial information and all past data may be represented by:

ϕₜ₋₁|x_{0:t-1}˜Ga(rₜ₋₁,cₜ₋₁)

where rₜ₋₁ and cₜ₋₁ are evaluated from past information x_{0:t-1}.

The Poisson rate evolves to time t via a Gamma-Beta evolution:

ϕₜ=ϕₜ₋₁ηₜ/δₜ, ηₜ˜Be(δₜrₜ₋₁,(1−δₜ)rₜ₋₁),

where the random “shock,” or innovation ηₜ, is independent of ϕₜ₋₁. A lower value of δₜ results in a more diffuse beta innovation distribution and an ability to adapt to changing rates over time, while a value closer to one indicates more stability. Thus, Bayesian model 208 may perform fast, flexible smoothing of a discrete time series (e.g., time-series data 218) with variation in the underlying latent process.

In Bayesian model 208, the beta innovations for ηₜ depend on the accumulated information at time t−1 through the shape parameter rₜ₋₁, and the discount factor δₜ decreases the information content between times t−1 and t. Moreover, the use of a beta distribution ensures that the prior distribution at time t has a conjugate gamma form.

The time t−1 gamma posterior above links with the beta innovation to give the time t−1 prior for the next state as:

ϕₜ|x_{0:t-1}˜Ga(δₜrₜ₋₁,δₜcₜ₋₁)

In turn, the prior for the new rate is more diffuse than the posterior at t−1, reflecting increased uncertainty due to evolution.

The one-step-ahead forecast distribution for xₜ may be represented by a generalized negative binomial distribution with the following probability density function:

$$p ( {x}_{t} \vert {x}_{0 : t - 1} , {δ}_{1 : t} ) = \frac{Γ ( {δ}_{t} {r}_{t - 1} + {x}_{t} )}{Γ ( {δ}_{t} {r}_{t - 1} ) Γ ( {x}_{t} + 1 )} \frac{{( {δ}_{t} {c}_{t - 1} )}^{{δ}_{t} {r}_{t - 1}}}{{( {δ}_{t} {c}_{t - 1} + 1 )}^{δ {r}_{t - 1} + {x}_{t}}}$$

After observing xₜ, the resulting posterior is ϕₜ|x_{0:t-1}˜Ga(rₜ, cₜ), which has the same form as that at time t−1 but with updated parameters rₜ=δₜrₜ₋₁+xₜ and cₜ=δₜcₜ₋₁+1.

The above assessment of Bayesian model 208 calculates a marginal likelihood as the product of one-step forecast probability density functions evaluated at the realized data. At time t, the product is represented by:

$$p ( {x}_{1 : t} \vert {x}_{0} , {δ}_{1 : t} ) = {\prod }_{s = 1 : t} p ( {x}_{s} \vert {x}_{0 : s - 1} , {δ}_{s} )$$

The product can be computed by evaluating the one-step-ahead forecast distribution above at xₜ:

p(x_{1:t}|x₀,δ_{1:t})=p(xₜ|x_{0:t-1},δ_{1:t})p(x_{1:t-1}|x₀,δ_{1:t-1})

In turn, the marginal likelihood can be used to compare models with different discount factor values. For example, the above equation may be used to calculate the marginal likelihood p(x_{1:t}|x₀, δ) at any chosen, fixed value of δₜ=δ. In parallel analyses using different values of δ, the log of the marginal likelihood accumulates linearly as data is sequentially processed. At any time t, the marginal likelihood can be mapped to a posterior p(δ|x_{0:t})∝p(δ|x₀)p(x_{1:t}|x₀, δ) and then normalized over the grid of values for inference on This may be used to choose a modal value for inference on ϕₜ that is conditional on a chosen δ and/or for model averaging.

After forward filtering 210 is performed for time steps 0 through T, analysis apparatus 204 performs backward smoothing 212 by revising the summary posterior distributions for the full trajectory of ϕ_{1:T} based on all the observed data. For example, analysis apparatus 204 may perform backward smoothing 212 of the mean of ϕ_{1:T} to generate pacing curve 214 from the mean.

During backward smoothing 212, analysis apparatus 204 calculates the final rate from the posterior of time T:

E(ϕ_{T}|x_{0:T},δ_{1:T})=r_{T}/c_{T}

Next, analysis apparatus 204 recurses backwards over times t=T−1, T−2, . . . , 1. For each time step, analysis apparatus 204 calculates the mean of ϕₜ from the implied p(ϕₜ|ϕ_{t+1:T}, X_{0:T}, δ_{1:T}) via E(ϕₜ|x_{0:T}, δ_{1:T}=δₜE(ϕₜ₊₁|x_{0:T}, δ_{1:T})+(1−δ₁)rₜ/cₜ. In turn, analysis apparatus 204 generates pacing curve 214 as a series of means of ϕₜ for t=1, 2, . . . , T.

After pacing curve 214 is produced, management apparatus 206 uses pacing curve 214 to carry out a pacing plan 240 for the corresponding activity. For example, management apparatus 206 may use pacing curve 214 to control the delivery of jobs, advertisements, and/or other content in the online system to users so that daily budgets for the content can be consumed over the course of each day instead of having the daily budgets run out prematurely or fail to be fully consumed before the end of the day. As a result, management apparatus 206 may surface content to the users in a more gradual and/or uniform manner and/or improve revenue generated from the content.

In particular, management apparatus 206 uses pacing plan 240 to determine, at a given time or time interval, an expected utilization 242 of a budget and/or other time-based constraint for an activity (e.g., view, clicks, applies, and/or other actions related to jobs, advertisements, and/or other content associated with the budget). Management apparatus 206 also obtains an actual utilization 246 of the budget for the activity up to that time. Management apparatus 206 then calculates a pacing score 244 that is used to adjust the occurrence of the activity in a way that substantially adheres to pacing curve 214.

For example, management apparatus 206 may calculate pacing score 244 using the following functions:

$$\begin{matrix}{pr}_{j , t} = f ( {pr}_{j , t - 1} , {f}_{projectSpend} , {B}_{j} * {f}_{expectRatio} ) \\ = {pr}_{j , t - 1} * exp ( 1 - {f}_{projectSpend} \text{/} ( {B}_{j} * {f}_{expectRatio} ) )\end{matrix}$$

$${pr}_{j , t} \leq 1 + {pr}_{boostRange}$$

In the above functions, pr_{j,t} represents pacing score 244 for job j at a time t. Pacing score 244 may be calculated as a function of the previous value of pacing score 244 (i.e., pacing score 244 from the previous time interval t−1), a value of actual utilization 246 represented by f_{projectSpend}, a daily budget for the job represented by Bⱼ, and a value of expected utilization 242 represented by f_{expectRatio}*Bⱼ. Actual utilization 246 may be obtained as the actual amount spent on the job's budget up to time t (e.g., the amount spent by the job's poster on views, clicks, and/or other interactions with the job). Expected utilization 242 may be calculated by multiplying the expected proportion of the job's budget to be consumed up to time t (e.g., at t=12:00 pm, 55% of the job's budget should be spent) by the job's daily budget.

More specifically, the above functions may be used to calculate pacing score 244 as the previous value of pacing score 244 multiplied by an exponential function, with the exponent in the exponential function calculated based on a ratio of actual utilization 246 to expected utilization 242. If actual utilization 246 is higher than expected utilization 242 (i.e., if spending of the job's budget is ahead of pacing plan 240), the value of the exponent is less than 1, and pacing score 244 is “throttled” compared to the previous value of pacing score 244. If actual utilization 246 is lower than expected utilization 242 (i.e., if spending of the job's budget is behind pacing plan 240), the value of the exponent is greater than 1, and pacing score 244 is “boosted” compared to the previous value of pacing score 244. Pacing score 244 further includes a lower bound of 0 (due to properties of the exponential function) and an upper bound of 1+pr_{boostRange}, where pr_{boostRange} is a maximum allowed lift for pacing score 244.

After pacing score 244 is calculated for multiple jobs and/or one or more dimensions 216 (e.g., users in a certain location) at a given time interval, management apparatus 206 generates a ranking of the jobs based on pacing score 244 and/or other factors. For example, management apparatus 206 may generate an overall score for each job as a weighted combination of pacing score 244; a user's predicted likelihood of clicking, applying to, and/or otherwise interacting with the job; and/or the cost per interaction (e.g., click, apply, etc.) with the job. Management apparatus 206 may rank a set of jobs by descending score and display the ranking to the user. Since the user is more likely to take action on higher-ranked jobs than on lower-ranked jobs, ranking of the jobs based on pacing score 244 may allow subsequent actions on the jobs to be increased or decreased accordingly. Management apparatus 206 repeats the process for subsequent time intervals, jobs, and/or dimensions 216, thus generating a different pacing score for each job-dimension combination at each interval.

By using Bayesian inference to generate smooth pacing plans for activities that are associated with time-based constraints, the system of FIG. 2 may introduce changes to pacing of the activities in a gradual, stable manner while temporally distributing the activities in a way that better meets the constraints. In contrast, conventional techniques may perform pacing based on unprocessed historical data, which can be inaccurate, noisy, and/or result in abrupt changes to user experiences (e.g., sudden changes in rankings and/or results in response to fluctuating pacing scores). Consequently, the disclosed embodiments may provide improvements in computer systems, applications, user experiences, tools, and/or technologies related to delivering online content and/or carrying out activities within online systems.

Those skilled in the art will appreciate that the system of FIG. 2 may be implemented in a variety of ways. First, stream-processing apparatus 202, analysis apparatus 204, management apparatus 206, and data repository 134 may be provided by a single physical machine, multiple computer systems, one or more virtual machines, a grid, one or more databases, one or more filesystems, and/or a cloud computing system. Stream-processing apparatus 202, analysis apparatus 204, and management apparatus 206 may additionally be implemented together and/or separately by one or more hardware and/or software components and/or layers.

Second, a number of techniques may be used to generate a smooth pacing curve 214 from time-series data 218. For example, the functionality of analysis apparatus 204 and/or Bayesian model 208 may be provided by a Kalman filter, non-linear filter, particle filter, state-space model, exponential smoothing technique, and/or another technique for estimating a distribution of a latent state from a series of observations.

Third, the functionality of the system may be adapted to various types of activities and/or pacing. For example, the system may be used to control and/or adjust the occurrence of user sessions, posts, comments, shares, messages, new member registrations, event registrations, class registrations, and/or other types of online activity to reflect limitations, constraints, and/or requirements associated with latency, bandwidth, storage, memory, input/output (I/O) devices, revenue, event capacity, class capacity, resource availability, and/or availability of new content.

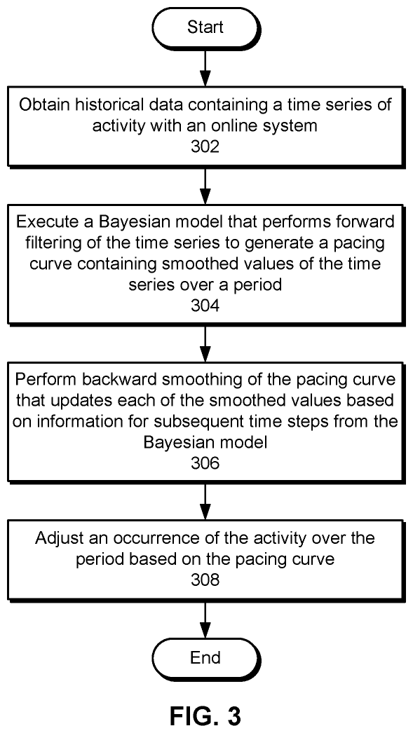

FIG. 3 shows a flowchart illustrating a process of pacing an activity in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, historical data containing a time series of activity within an online system is obtained (operation 302). For example, the historical data may include a number of weeks and/or months of views, clicks, applies, purchases, conversions, and/or other interactions with jobs, advertisements, and/or other content delivered within the online system. The time series may be produced by aggregating the interactions within predefined intervals (e.g., consecutive five-minute intervals over a week) and/or by one or more dimensions (e.g., location, industry, seniority, education, company, company size, etc.).

Next, a Bayesian model that performs forward filtering of the time series is executed to generate a pacing curve containing smoothed values of the time series over a period (operation 304). For example, the Bayesian model may determine a distribution of a latent variable representing the activity at a given current time step based on a previous distribution of the latent variable at a previous time step, a value of the time series (i.e., an observation of the activity) at the time step, and/or a discount factor. The discount factor may optionally be selected based on a marginal likelihood for the Bayesian model.

Backward smoothing of the pacing curve that updates each of the smoothed values based on information for subsequent time steps from the Bayesian model is then performed (operation 306). For example, backward smoothing may be performed by adjusting the mean of the distribution of the latent variable at a given current time step based on a subsequent distribution of the latent variable at a subsequent time step, the time series, and/or the discount factor. The pacing curve may subsequently be generated from the mean of the distribution at each time step within the period (e.g., every five-minute interval in a day or a week).

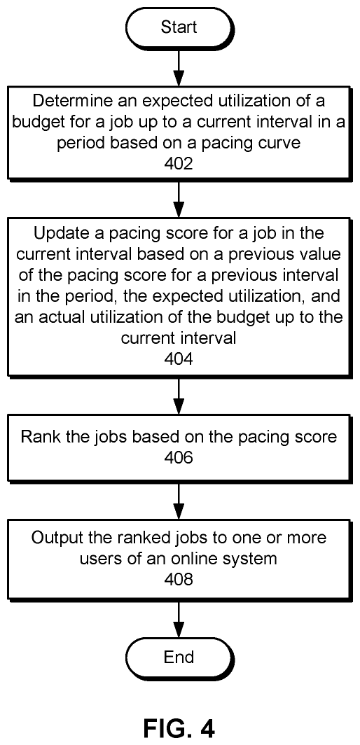

Finally, an occurrence of the activity over the period is adjusted based on the pacing curve (operation 308). For example, the pacing curve may be used to boost or throttle the delivery of jobs to users at each five-minute time interval over a one-day period to ensure that the daily budgets for the jobs are consumed throughout the day, as described in further detail below with respect to FIG. 4. In general, the activity's occurrence may be adjusted by determining an expected occurrence of the activity up to a current interval in the period based on the pacing curve and adjusting a subsequent occurrence of the activity based on the expected occurrence and an actual occurrence of the activity up to the current interval.

FIG. 4 shows a flowchart illustrating a process of using a pacing curve to adjust an occurrence of interactions with a job in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, an expected utilization of a budget for a job up to a current interval in a period is determined based on a pacing curve (operation 402). For example, the pacing curve may indicate, at each five-minute interval within a one-day period, the proportion of the budget that is expected to be consumed up to the interval.

Next, a pacing score for a job in the current interval is updated based on a previous value of the pacing score for a previous interval in the period, the expected utilization, and an actual utilization of the budget up to the current interval (operation 404). For example, the pacing score may be increased over the previous value when the actual utilization of the budget at the current interval falls below the expected utilization for the current interval. Conversely, the pacing score may be decreased over the previous value when the actual utilization at the current interval is higher than the expected utilization for the current interval.

The jobs are then ranked based on the pacing score (operation 406). For example, a pacing score that is lower than the previous value may cause the corresponding job's position in a ranking to drop, thereby reducing the likelihood that a user interacts with the job after viewing the ranking. On the other hand, a pacing score that is higher than the previous value may cause the corresponding job's position in the ranking to increase, thus increasing the likelihood that a user interacts with the job after viewing the ranking. In other words, the pacing score may be used to “throttle” or “boost” user interactions with the job so that the budget for the job is consumed according to the pacing curve instead of running out prematurely or failing to be fully consumed by the end of the period.

Finally, the ranked jobs are outputted to one or more users of an online system (operation 408). For example, rankings of jobs may be generated as search results for job searches performed by the users and/or job recommendations that delivered in emails to the users and/or displayed to the users within a “jobs module” or another portion of an online network (e.g., online network 118 of FIG. 1). As the pacing scores of the jobs change over time, the rankings may be updated to increase the visibility of jobs that are lagging behind their pacing curves and/or decrease the visibility of jobs that are ahead of their pacing curves.

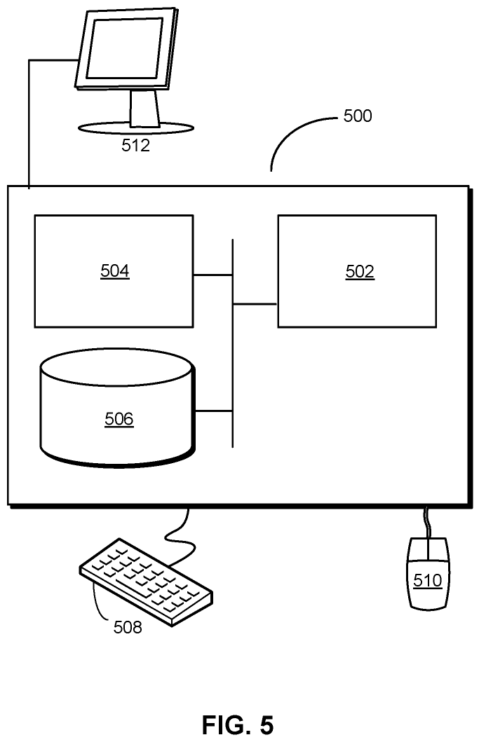

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing bidirectional smoothing of activity pacing plans. The system includes a stream-processing apparatus, an analysis apparatus, and a management apparatus, one or more of which may alternatively be termed or implemented as a module, mechanism, or other type of system component. The stream-processing apparatus obtains historical data containing a time series of an activity, such as interactions with jobs within an online system. Next, the analysis apparatus executes a Bayesian model that performs forward filtering of the time series to generate a pacing curve containing smoothed values of the time series over a period. The analysis apparatus also performs a backward smoothing that updates each of the smoothed values based on information for subsequent time steps from the Bayesian model. The management apparatus then adjusts an occurrence of the activity over the period based on the pacing curve and/or a budget associated with the activity over the period (e.g., a daily budget for clicks on jobs posted within the online system).

In addition, one or more components of computer system 500 may be remotely located and connected to the other components over a network. Portions of the present embodiments (e.g., stream-processing apparatus, analysis apparatus, management apparatus, data repository, online network, etc.) may also be located on different nodes of a distributed system that implements the embodiments. For example, the present embodiments may be implemented using a cloud computing system that controls the delivery of jobs, advertisements, and/or other content to a set of remote users based on time-based constraints associated with the content.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining historical data comprising a time series of interactions with jobs within an online system;
executing, by one or more computer systems, a Bayesian model that performs forward filtering of the time series to generate a pacing curve comprising smoothed values of the time series over a period; and
adjusting an occurrence of the interactions over the period based on the pacing curve and a budget for the jobs over the period.

2. The method of claim 1, further comprising:
performing a backward smoothing that updates each of the smoothed values based on information for subsequent time steps from the Bayesian model.

3. The method of claim 2, wherein performing the backward smoothing that updates each of the smoothed values based on information for subsequent time steps from the Bayesian model comprises:
adjusting a mean of a distribution of a latent variable associated with the activity at a current time step based on a subsequent distribution of the latent variable at a subsequent time step, the time series, and a discount factor.

4. The method of claim 1, wherein obtaining the historical data comprising the time series of interactions with jobs within the online system comprises:
aggregating values of the time series by one or more dimensions over the period.

5. The method of claim 4, wherein the one or more dimensions comprise a location.

6. The method of claim 1, wherein executing the Bayesian model that performs forward filtering of the time series to generate the pacing curve comprising the smoothed values of the time series over the period comprises:
determining a distribution of a latent variable associated with the activity at a current time step based on a previous distribution of the latent variable at a previous time step, a value of the time series at the time step, and a discount factor.

7. The method of claim 6, wherein executing the Bayesian model that performs forward filtering of the time series to generate the pacing curve comprising the smoothed values of the time series over the period further comprises:
selecting the discount factor based on a marginal likelihood for the Bayesian model.

8. The method of claim 6, wherein the distribution comprises a Gamma distribution.

9. The method of claim 1, wherein adjusting the occurrence of the interactions over the period comprises:
determining an expected utilization of the budget for the job up to a current interval in the period based on the pacing curve; and
updating a pacing score for a job in the current interval based on a previous value of the pacing score for a previous interval in the period, the expected utilization, and an actual utilization of the budget up to the current interval;
ranking the jobs based on the pacing score; and
outputting the ranked jobs to one or more users in the online system.

10. The method of claim 9, wherein updating the pacing score comprises:
increasing the pacing score when the actual utilization is lower than the expected utilization; and
reducing the pacing score when the actual utilization is higher than the expected utilization.

11. The method of claim 1, wherein the interactions comprise at least one of:
a view;
a click; and
a job application.

12. A method, comprising:
obtaining historical data comprising a time series of activity with an online system;
executing, by one or more computer systems, a Bayesian model that performs forward filtering of the time series to generate a pacing curve comprising smoothed values of the time series over a period;
performing, by the one or more computer systems, a backward smoothing that updates each of the smoothed values based on information for subsequent time steps from the Bayesian model; and
adjusting an occurrence of the activity over the period based on the pacing curve.

13. The method of claim 12, wherein executing the Bayesian model that performs forward filtering of the time series to generate the pacing curve comprising the smoothed values of the time series over the period comprises:
determining a distribution of a latent variable associated with the activity at a current time step based on a previous distribution of the latent variable at a previous time step, a value of the time series at the time step, and a discount factor.

14. The method of claim 13, wherein executing the Bayesian model that performs forward filtering of the time series to generate the pacing curve comprising the smoothed values of the time series over the period further comprises:
selecting the discount factor based on a marginal likelihood for the Bayesian model.

15. The method of claim 12, wherein performing the backward smoothing that updates each of the smoothed values based on information for subsequent time steps from the Bayesian model comprises:
adjusting a mean of a distribution of a latent variable associated with the activity at a current time step based on a subsequent distribution of the latent variable at a subsequent time step, the time series, and a discount factor.

16. The method of claim 12, wherein obtaining the historical data comprising the time series of activity with the online system comprises:
aggregating values of the time series by one or more dimensions over the period.

17. The method of claim 12, wherein adjusting the occurrence of the activity over the period comprises:
determining an expected occurrence of the activity up to a current interval in the period based on the pacing curve; and
adjusting a subsequent occurrence of the activity based on the expected occurrence and an actual occurrence of the activity up to the current interval.

18. The method of claim 12, wherein the activity comprises interaction with content in the online system.

19. A non-transitory computer-readable storage medium storing instructions that when executed by a computer cause the computer to perform a method, the method comprising:
obtaining historical data comprising a time series of interactions with jobs within an online system;
executing, by one or more computer systems, a Bayesian model that performs forward filtering of the time series to generate a pacing curve comprising smoothed values of the time series over a period; and
adjusting an occurrence of the interactions over the period based on the pacing curve and a budget for the jobs over the period.

20. The non-transitory computer-readable storage medium of claim 19, the method further comprising:
performing a backward smoothing that updates each of the smoothed values based on information for subsequent time steps from the Bayesian model.
